(19) United States
(12) Patent Application Publication
(10) Pub. No.: US 2023/0411691 A1
(43) Pub. Date: Dec. 21, 2023

(54) Electrolyte and Lithium-ion Battery

(71) Applicant: EVE POWER CO., LTD., Jingmen (CN)

(72) Inventors: Chi Li, Jingmen (CN); Heng Zhang, Jingmen (CN); Fanfen Liu, Jingmen (CN); Dingding Yuan, Jingmen (CN)

(21) Appl. No.: 18/241,218

(22) Filed: Aug. 31, 2023

(30) Foreign Application Priority Data
Nov. 25, 2022 (CN) 202211493181.7

(51) Int. Cl. H01M 10/0567; H01M 10/0525; H01M 10/0568; H01M 10/0569; H01M 4/58; H01M 4/136; H01M 4/587; H01M 4/133

(52) U.S. Cl. CPC H01M 10/0567; H01M 10/0525; H01M 10/0568; H01M 10/0569; H01M 4/5825; H01M 4/136; H01M 4/587; H01M 4/133; H01M 2300/004

(57) ABSTRACT

Provided in the present application is an electrolyte and lithium-ion battery. The electrolyte includes a compound as shown in formula 1, in which R₁ is selected from any one of C1-C6 fully or partially substituted fluoroalkyl, and R₂ and R₃ are independently selected from any one of a hydrogen atom, an alkane, a phenyl, an alkylbenzene, or a methoxysilane respectively.

### CROSS-REFERENCE TO RELATED APPLICATIONS

The present application claims priority of Chinese Patent Application No. 202211493181.7 filed on Nov. 25, 2022, the contents of which are hereby incorporated by reference in their entirety.

### FIELD

The present application relates to the field of lithium-ion battery, and relates to an electrolyte, and in particular to an electrolyte and lithium-ion battery.

### BACKGROUND

In recent years, with vigorous promotion of new energy vehicles and the implementation of subsidy policies, the demand for lithium batteries has grown dramatically. With the popularization of new energy vehicles, there are increasingly higher requirements for the energy density of lithium-ion batteries on the market, and how to improve the energy density of lithium batteries in the same volume space is a common pursuit of numerous products. The main methods to improve the energy density of the battery are: 1. increasing the coating surface density and compaction density, and increasing the proportion of positive and negative active substances per unit volume; 2. reducing the proportion of auxiliary materials per unit volume, such as the selection of thinner collectors and separators; 3. reducing the amount of injected electrolyte.

With the increase of coating surface density and compaction density, although the energy density of the battery is greatly improved, it brings also problems that the use of traditional electrolyte leads to the deterioration of the wettability of the electrode sheet and the increase of the liquid absorption time. On the one hand, it leads to a reduction in battery production efficiency. On the other hand, it results in poor liquid absorption consistency, deterioration of cycling performance and safety issues such as lithium precipitation from the negative electrode. Therefore, a new type of high-wettability electrolyte is a practical and effective approach to solve the problem of poor wettability in high surface-density and highly compressed electrode sheets.

Disclosed in the related prior art is a lithium metal battery electrolyte including an aromatic compound as a diluent, the diluent being an aromatic compound, which may be used for suppressing lithium dendrites due to uneven deposition of lithium metal anode in lithium metal batteries during cycling, so as to improve the wettability performance of the electrolyte.

Disclosed in the related prior art are a high wettability electrolyte for lithium metal batteries and lithium-ion batteries. The additives to improve wettability are m-toluene sulfonate-based y additives, which improve the liquid absorption efficiency of the positive and negative electrode sheets of lithium metal batteries and improve the wettability of the electrolyte.

However, the related prior technologies are applied in lithium metal battery modification, with limited application scenarios and limited improved performance for batteries, so how to prepare a novel high-wettability electrolyte applied to commercial batteries is an important research direction in the art.

### SUMMARY

In view of the deficiencies existing in the prior art, the objective of the present application is to provide an electrolyte and lithium-ion battery with high wettability.

To achieve the objective, the following technical solutions are adopted in the present application.

As a first aspect, provided in the present application is an electrolyte, the electrolyte including a compound as shown in formula 1,

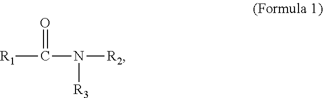

wherein R₁ is selected from any one of C1-C6 fully or partially substituted fluoroalkyl, and R₂ and R₃ are independently selected from any one of a hydrogen atom, an alkane, a phenyl, an alkylbenzene, or a methoxysilane, respectively.

The compound shown in Formula 1 of the present application has a structure of a nonionic fluorocarbon surfactant containing both an amide group as a polar group and a carbon-fluorine bond as a nonpolar group. The structure of carbon-fluorine bond is stable and difficult to be polarized, which enables the fluorocarbon chain to be hydrophobic and oleophobic simultaneously. Therefore, the additive shows a stronger tendency to detach from the solution than other surface-active molecules, which is directed to aggregate and arrange into a molecular film at the liquid/gas interface. Therefore, even under an extremely low concentration of the electrolyte, the additive may significantly reduce the surface tension of the electrolyte, improve the wettability of the electrolyte, and increase the contact between the electrolyte and the solid phase in the deep pore spaces of the thick electrodes, so as to reduce the internal resistance of the battery, and increase the rate performance, cycling performance and so on. In addition, the compound shown in Formula 1 also provides high thermal stability and chemical stability, which may greatly improve the wettability of the electrolyte in the thick electrode and not deteriorate the performance of the electrolyte.

In one implementation, the electrolyte includes any one of compounds as shown in Formula 2 to Formula 5,

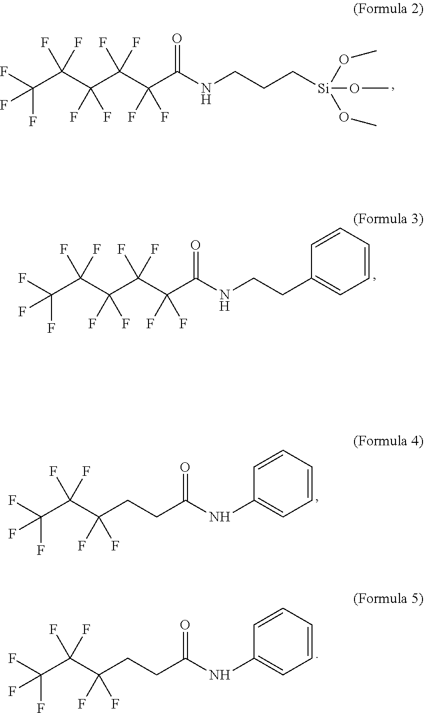 [SMILES: CO[Si](CCCNC(=O)C(F)(F)C(F)(F)C(F)(F)C(F)(F)C(F)(F)F)(OC)OC ; O=C(NCCc1ccccc1)C(F)(F)C(F)(F)C(F)(F)C(F)(F)C(F)(F)F ; O=C(CCC(F)(F)C(F)(F)C(F)(F)F)Nc1ccccc1 ; O=C(CCC(F)(F)C(F)(F)C(F)(F)F)Nc1ccccc1]

In one implementation, a mass fraction of the compound as shown in Formula 1 in the electrolyte is 0.1˜0.5%, in which the mass fraction thereof may be, but is not limited to, such as 0.2%, 0.3%, 0.4% and 0.5%. Other values not listed in the range are also applicable, which is preferably 0.1˜0.3%.

In one implementation, the electrolyte also includes an additive.

In one implementation, the additive including vinylidene carbonate, tris(trimethylsilyl) phosphite and vinyl sulfate.

In one implementation, a mass fraction of the vinylidene carbonate in the electrolyte is in which the mass fraction thereof may be, but is not limited to, such as 0.3%, 0.6%, 1.2%, 1.5%, 1.8%, 2.1%, 2.4%, 2.7%, 3.0%, 3.3% and 3.5%. Other values not listed in the range are also applicable.

In one implementation, a mass fraction of the tris(trimethylsilyl) phosphite in the electrolyte is 0.3˜3.5%, in which the mass fraction thereof may be, but is not limited to, such as 0.6%, 0.9%, 1.2%, 1.5%, 1.8%, 2.1%, 2.4%, 2.7%, 3.0%, 3.3% and 3.5%. Other values not listed in the range are also applicable.

In one implementation, a mass fraction of the vinyl sulfate in the electrolyte is 0.3˜3.5%, in which the mass fraction thereof may be, but is not limited to, such as 0.3%, 0.6%, 0.9%, 1.2%, 1.5%, 1.8%, 2.1%, 2.4%, 2.7%, 3.0%, 3.3% and 3.5%. Other values not listed in the range are also applicable.

In one implementation, the electrolyte also includes a lithium salt.

In one implementation, the lithium salt includes any one or a combination of at least two of LiPF₆, LiClO₄, LiBF₄, LiPO₂F₂, LiODFB, LiTFSI and LiFSI, in which the typical but non-limiting examples of the combinations are such as a combination of LiPF₆ and LiClO₄, a combination of LiClO₄ and LiBF₄, a combination of LiBF₄ and LiPO₂F₂, a combination of LiPO₂F₂ and LiODFB, a combination of LiODFB and LiTFSI, and a combination of LiTFSI and LiFSI.

In one implementation, the lithium salt is LiPF₆.

In one implementation, a mass fraction of the lithium salt in the electrolyte is 8˜12%, in which the mass fraction thereof may be, but is not limited to, such as 8%, 9%, 10%, 11% and 12%. Other values not listed in the range are also applicable.

In one implementation, the electrolyte also includes an organic solvent, the organic solvent including at least two of ethylene carbonate, propylene carbonate, dimethyl carbonate, diethyl carbonate, methyl ethyl carbonate, propylene sulfite, ethyl acetate, diethyl sulfite, and 1,3-propanesultone.

In one implementation, the organic solvent includes at least two of ethylene carbonate, propylene carbonate, dimethyl carbonate, diethyl carbonate and ethyl methyl carbonate.

In one implementation, a mass fraction of the ethylene carbonate in the electrolyte is 20˜30%, in which the mass fraction thereof may be, but is not limited to, such as 20%, 21%, 22%, 23%, 24%, 25%, 26%, 27%, 28%, 29% and 30%. Other values not listed in the range are also applicable.

In one implementation, a mass fraction of the ethyl methyl carbonate in the electrolyte is 30˜40%, in which the mass fraction thereof may be, but is not limited to, such as 30%, 31%, 32%, 33%, 34%, 35%, 36%, 37%, 38%, 39% and 40%. Other values not listed in the range are also applicable.

In one implementation, a mass fraction of the dimethyl carbonate in the electrolyte is 30˜50%, in which the mass fraction thereof may be, but is not limited to, such as 30%, 32%, 34%, 36%, 38%, 40%, 42%, 44%, 46%, 48% and 50%. Other values not listed in the range are also applicable.

As a second aspect, provided in the present application is a lithium-ion battery, the lithium-ion battery includes a positive electrode sheet, a negative electrode sheet, a separator and the electrolyte as described in the first objective.

In one implementation, the positive electrode sheet includes a positive current collector and a cathode material provided on the positive current collector.

In one implementation, the cathode material includes positive electrode active substance, the positive electrode active substance including lithium iron phosphate.

In one implementation, the negative electrode sheet includes a negative current collector and an anode material provided on the negative current collector.

In one implementation, the anode material includes negative electrode active substance, the negative electrode active substance including graphite.

Compared to the prior art, the present application has beneficial effects as follows.

By adding the compound shown in Formula 1 to the electrolyte prepared in the present application, the viscosity and surface tension of the electrolyte may be reduced, and the wettability of the electrolyte in a high surface-density and highly-compressed battery system may be significantly improved, thereby increasing the production efficiency, and the rate performance and cycling performance of the battery may also be improved.

### DETAILED DESCRIPTION OF THE PREFERRED EXAMPLES

The technical solutions of the present application are further described hereinafter with specific examples.

### Example 1

Provided in the present example is an electrolyte, the electrolyte including a compound as shown in formula 2, a lithium salt, an additive and an organic solvent.

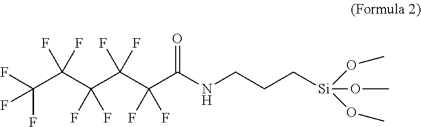 [SMILES: CO[Si](CCCNC(=O)C(F)(F)C(F)(F)C(F)(F)C(F)(F)C(F)(F)F)(OC)OC]

A mass fraction of the compound as shown in Formula 2 in the electrolyte is 0.3%.

The lithium salt is lithium hexafluorophosphate, a mass fraction of the lithium salt in the electrolyte is 10%.

The additives are vinylidene carbonate (VC), tris(trimethylsilyl)phosphite (TMSP) and vinylidene sulfate (DTD). In the electrolyte, the mass fraction of the vinylidene carbonate is 3.0%, the mass fraction of the tris(trimethylsilyl)phosphite is 0.5% and the mass fraction of the vinylidene sulfate is 0.3%.

The remaining of the electrolyte is organic solvents, which are ethylene carbonate (EC), ethyl methyl carbonate (EMC) and dimethyl carbonate (DMC) in the mass ratio of 3:4:3.

Provided in the present example is also a lithium-ion battery and a preparation method thereof.

The lithium-ion battery is a lithium iron phosphate battery with square aluminum shell, with a capacity distribution of 160Ah at room temperature, a charging and discharging voltage range of 2.5˜3.65V, and a continuous cycle of 1 C rate at both room and high temperatures.

Preparation of positive electrode sheet: LiFePO₄: Super-P Conductive Carbon Black (SP): Carbon nanotube (CNT): Polyvinylidene fluoride (PVDF)=95.0:2.0:0.5:2.5. Positive electrode gel solution is made by PVDF and the solid content of the gels is 1.327%. In the first step, LiFePO4, SP, and N-Methylpyrrolidone (NMP) are added, with a rotation of 25±1 r/min, a dispersion of 500±50 r/min, stirring for 10 min, then a rotation speed of 25±1 r/min, a dispersion speed of 1000±50 r/min, stirring at 45 ° C. for 90 min. In the second step, the conductive CNT slurry is added, with a rotation speed of 25±1 r/min, a dispersion of 1000±50 r/min, a vacuum level of 0.080 KPa, and stirring at 45° C. for 60 min. In the third step, the positive electrode gel solution is added, with a rotation speed of 25±1 r/min, a dispersion speed of 2500±50 r/min, a vacuum level of 0.080 KPa, and stirring for 90 min at 45° C. The fourth step is the viscosity adjustment step, adding NMP to adjust the viscosity of the slurry. The fifth step is to stir slowly, with a rotation speed of 15±1 r/min, a dispersion speed of 500±50 r/min, a vacuum level of 0.080 KPa, and stirring for 0.5h to cool down. Ensuring that the viscosity of the positive output material is 20000±5000 mPa·s, and the fineness is ≤15 μm. Promptly scrape deposited material from the wall of the stirring cylinder and the stirring rod at each step. After sieving, coating, cold pressing and slitting, the positive electrode sheet is prepared.

Preparation of negative electrode sheet: Graphite: Super-P Conductive Carbon Black (SP): carboxymethylcellulose (CMC): styrene-butadiene rubber (SBR)=95.5: 1.5: 1.2: 1.8. Negative electrode gel solution is made by CMC and the solid content of the gels is 8%. In the first step, graphite and SP are added to be mixed, with a rotation of 20±1 r/min, a dispersion speed of 1000±50 r/min, and stirring for 1 h. In the second step, 50% negative electrode slurry is added, with a rotation speed of 20±1 r/min, a dispersion speed of 1000±50 r/min, and stirring for 1.5 h. In the third step, the other 50% of negative electrode slurry is added, with a rotation of 25±1 r/min, a dispersion speed of 2000±50 r/min, a vacuum level of KPa, and stirring for lh. The fourth step is the viscosity adjustment step, adding deionized water to adjust the viscosity of the slurry. In the fifth step, the aqueous dispersant SBR is added, with a rotation speed of 25±1 r/min, a dispersion speed of 800±50 r/min, a vacuum level of 0.085 KPa, and stirring for 1 h to finish. Ensuring that the viscosity of the negative output material is 4000±1500 mPa·s, and the fineness is ≤20 μm. Promptly scrape deposited material from the wall of the stirring cylinder and the stirring rod at each step. After sieving, coating, cold pressing and slitting, the negative electrode sheet is prepared.

A lithium-ion battery is assembled by combining the above-mentioned positive electrode sheet, negative electrode sheet and electrolyte.

### Example 2

All other operations of Example 2 are the same as in Example 1, except that the compound of Formula 2 in Example 1 is replaced with a compound of Formula 3.

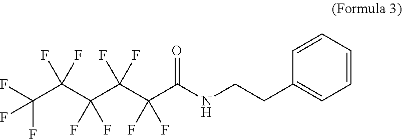 [SMILES: O=C(NCCc1ccccc1)C(F)(F)C(F)(F)C(F)(F)C(F)(F)C(F)(F)F]

### Example 3

All other operations of Example 3 are the same as in Example 1, except that the compound of Formula 2 in Example 1 is replaced with a compound of Formula 4.

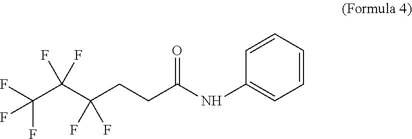 [SMILES: O=C(CCC(F)(F)C(F)(F)C(F)(F)F)Nc1ccccc1]

### Example 4

All other operations of Example 4 are the same as in Example 1, except that the compound of Formula 2 in Example 1 is replaced with a compound of Formula 5.

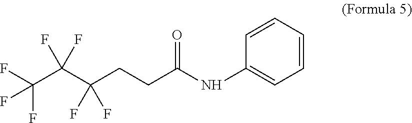 [SMILES: O=C(CCC(F)(F)C(F)(F)C(F)(F)F)Nc1ccccc1]

### Example 5

All other operations of Example 5 are the same as in Example 1, except that the organic l solvent is replaced with EC:EMC=3:7 (Mass Fraction)

### Example 6

All other operations of Example 6 are the same as in Example 1, except that the mass fraction of lithium salt is changed to 13%.

### Example 7

All other operations of Example 7 are the same as in Example 1, except that the mass fraction of the compound of Formula 2 is changed to 0.7%.

### Contrast Example 1

All other operations of Contrast Example 1 are the same as in Example 1, except that the compound of Formula 2 of the present application is not included.

### Contrast Example 2

All other operations of Contrast Example 2 are the same as in Example 1, except that the compound of Formula 2 of the present application is replaced with fluorobenzene.

### Contrast Example 3

All other operations of Contrast Example 3 are the same as in Example 1, except that a mass ratio of the organic solvent is replaced with EC:EMC:DMC=3:2:5, and a mass fraction of the additive is replaced with VC 1.5%+DTD 1.0%+LiPO₂F_{2 0.5}%+PS 0.8%.

The electrolyte composition and content in Examples 1-7 and Contrast Examples 1-3 are shown in Table 1 below.

TABLE 1

| | | | Lithium |
|---|---|---|---|
| | Organic Solvent | Additive | Salt |
| Example 1 | EC:EMC:DMC = | VC 3.0% + DTD 0.5% + TMSP | 10% |
| | 3:4:3 | 0.3% + Formula 2 0.3% | |
| Example 2 | EC:EMC:DMC = | VC 3.0% + DTD 0.5% + TMSP | 10% |
| | 3:4:3 | 0.3% + Formula 3 0.3% | |
| Example 3 | EC:EMC:DMC = | VC 3.0% + DTD 0.5% + TMSP | 10% |
| | 3:4:3 | 0.3% + Formula 4 0.3% | |
| Example 4 | EC:EMC:DMC = | VC 3.0% + DTD 0.5% + TMSP | 10% |
| | 3:4:3 | 0.3% + Formula 5 0.3% | |
| Example 5 | EC:EMC = | VC 3.0% + DTD 0.5% + TMSP | 10% |
| | 3:7 | 0.3% + Formula 2 0.3% | |
| Example 6 | EC:EMC:DMC = | VC 3.0% + DTD 0.5% + TMSP | 13% |
| | 3:4:3 | 0.3% + Formula 2 0.3% | |
| Example 7 | EC:EMC:DMC = | VC 3.0% + DTD 0.5% + TMSP | 10% |
| | 3:4:3 | 0.3% + Formula 2 0.7% | |
| Contrast | EC:EMC:DMC = | VC 3.0% + DTD 0.5% + | 10% |
| Example 1 | 3:4:3 | TMSP 0.3% | |
| Contrast | EC:EMC:DMC = | VC 3.0% + DTD 0.5% + TMSP | 10% |
| Example 2 | 3:4:3 | 0.3% + Fluorobenzene 0.3% | |
| Contrast | EC:EMC:DMC = | VC 1.5% + DTD 1.0% + | 10% |
| Example 3 | 3:2:5 | LiPO₂F₂ 0.5% + PS 0.8% | |

The electrolyte wettability of the lithium-ion batteries prepared in the above Examples 1-7 and Contrast Examples 1-3 is tested, and the test results are shown in Table 2.

Electrolyte wettability is tested as follows.

1. Slitting strips with a width of 15 mm and a length of 115 mm along the longitudinal direction of the electrode sheet with a slicing machine (3 groups in total);

2. Taking the electrolyte of the above groups, and dipping the cold-pressed positive electrode sheet and negative electrode sheet (positive electrode is tested first) into the electrolyte at equal height respectively;

3. Testing in the environment of the liquid injection room of the flexible packaging line, recording the climbing height of the electrolyte within 10 min, and recording the average value of the climbing height of the ten groups of electrolytes.

TABLE 2

| | Electrolyte Wettability Test | |
|---|---|---|
| | Climbing height of positive | Climbing height of negative |
| | electrode sheet (mm) | electrode sheet (mm) |
| Example 1 | 11.5 | 15.5 |
| Example 2 | 11.2 | 15.5 |
| Example 3 | 11.3 | 15.4 |
| Example 4 | 11.2 | 15.4 |
| Example 5 | 10.4 | 14.3 |
| Example 6 | 10.8 | 14.5 |
| Example 7 | 10.5 | 14.6 |
| Contrast | 8.7 | 11.5 |
| Example 1 | | |
| Contrast | 9.9 | 13.6 |
| Example 2 | | |
| Contrast | 9.1 | 12.7 |
| Example 3 | | |

From the table above, it is evident that Examples 1-4 adopt different structures of compounds as shown in Formula 1, and the electrolyte provides good wettability performance for both the positive electrode sheet and the negative electrode sheet. After changing the proportion of the organic solvent in Example 5, the wettability performance of the electrolyte on the positive electrode sheet and the negative electrode sheet deteriorates, and therefore, the optimal organic solvent proportion of the electrolyte is EC:EMC:DMC=3:4:3. Too much lithium salt is added in Example 6, resulting in a significant decrease in the wettability performance of the electrolyte. The excessive amount of the compound of Formula 2 in Example 7 decreases the wettability performance of the electrolyte.

The compound as shown in Formula 1 is not added in Contrast Example 1; the compound as shown in Formula 1 is replaced with fluorobenzene in Contrast Example 2; the compound as shown in Formula 1 is replaced with PS in Contrast Example 3, and the proportion of the organic solvent is modified to EC:EMC:DMC=3:2:5; and it is to be noted that a significant deterioration of the electrolyte wettability performance occurs in all of the electrolyte in Contrast Example 1-3.

1. An electrolyte, the electrolyte comprising a compound as shown in formula 1, 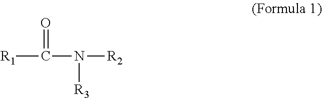
wherein R₁ is selected from any one of C1-C6 fully or partially substituted fluoroalkyl, and R₂ and R₃ are independently selected from any one of hydrogen atom, alkane, phenyl, alkylbenzene, or methoxysilane respectively.

2. The electrolyte according to claim 1, wherein the electrolyte comprises any one of compounds as shown in Formula 2 to Formula 5,

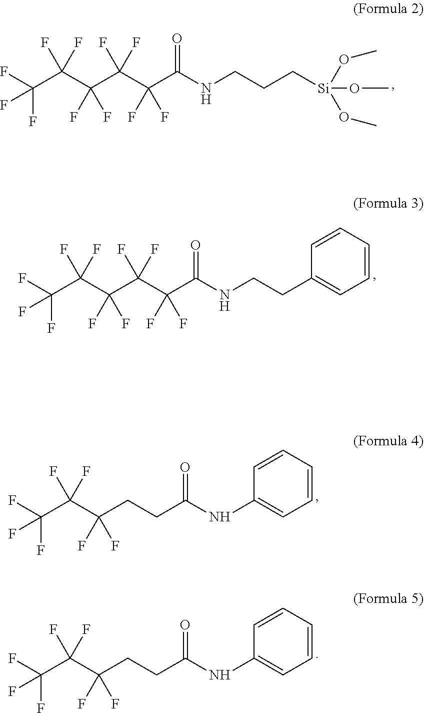 [SMILES: CO[Si](CCCNC(=O)C(F)(F)C(F)(F)C(F)(F)C(F)(F)C(F)(F)F)(OC)OC ; O=C(NCCc1ccccc1)C(F)(F)C(F)(F)C(F)(F)C(F)(F)C(F)(F)F ; O=C(CCC(F)(F)C(F)(F)C(F)(F)F)Nc1ccccc1 ; O=C(CCC(F)(F)C(F)(F)C(F)(F)F)Nc1ccccc1]

3. The electrolyte according to claim 1, wherein a mass fraction of the compound as shown in formula 1 in the electrolyte is 0.10.5%.

4. The electrolyte according to claim 3, wherein a mass fraction of the compound as shown in formula 1 in the electrolyte is 0.10.3%.

5. The electrolyte according to claim 1, wherein the electrolyte also comprises an additive, the additive comprising vinylidene carbonate, tris(trimethylsilyl) phosphite and vinyl sulfate.

6. The electrolyte according to claim 5, wherein a mass fraction of the vinylidene carbonate in the electrolyte is 0.33.5%.

7. The electrolyte according to claim 5, wherein a mass fraction of the tris(trimethylsilyl) phosphite in the electrolyte is 0.33.5%.

8. The electrolyte according to claim 5, wherein a mass fraction of the vinyl sulfate in the electrolyte is 0.33.5%.

9. The electrolyte according to claim 1, wherein the electrolyte also comprises a lithium salt, the lithium salt comprising any one or a combination of at least two of LiPF₆, LiClO₄, LiBF₄, LiPO₂F₂, LiODFB, LiTFSI and LiFSI.

10. The electrolyte according to claim 9, wherein the lithium salt is LiPF6.

11. The electrolyte according to claim 9, wherein a mass fraction of the lithium salt in the electrolyte is 8˜12%.

12. The electrolyte according to claim 1, wherein the electrolyte also comprises an organic solvent, the organic solvent comprising at least two of ethylene carbonate, propylene carbonate, dimethyl carbonate, diethyl carbonate, methyl ethyl carbonate, propylene sulfite, ethyl acetate, diethyl sulfite, and 1,3-propanesultone.

13. The electrolyte according to claim 12, wherein the organic solvent comprises at least two of ethylene carbonate, propylene carbonate, dimethyl carbonate, diethyl carbonate and ethyl methyl carbonate.

14. The electrolyte according to claim 13, wherein a mass fraction of the ethylene carbonate in the electrolyte is 20˜30%.

15. The electrolyte according to claim 13, wherein a mass fraction of the methyl ethyl carbonate in the electrolyte is 30˜40%.

16. The electrolyte according to claim 13, wherein a mass fraction of the dimethyl carbonate in the electrolyte is 30˜50%.

17. A lithium-ion battery, wherein the lithium-ion battery comprises a positive electrode sheet, a negative electrode sheet, a separator and an electrolyte, the electrolyte comprising a compound as shown in formula 1, 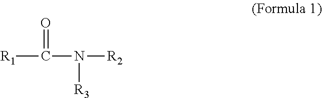
wherein R₁ is selected from any one of C1-C6 fully or partially substituted fluoroalkyl, and R₂ and R₃ are independently selected from any one of hydrogen atom, alkane, phenyl, alkylbenzene, or methoxysilane respectively.

18. The lithium-ion battery according to claim 17, wherein the positive electrode sheet comprises a positive current collector and a cathode material provided on the positive current collector; and
the cathode material comprises positive electrode active substance, the positive electrode active substance comprising lithium iron phosphate.

19. The lithium-ion battery according to claim 17, wherein the negative electrode sheet comprises a negative current collector and an anode material provided on the negative current collector.

20. The lithium-ion battery according to claim 19, wherein the anode material comprises negative electrode active substance, the negative electrode active substance comprising graphite.
